(19) United States
(12) Patent Application Publication
(10) Pub. No.: US 2011/0043363 A1
(43) Pub. Date: Feb. 24, 2011

(54) RADIO FREQUENCY IDENTIFICATION TAG, AND METHOD AND MOLD FOR MANUFACTURING THE SAME

(75) Inventors: Woon Chun Kim, Suwon (KR); Hyun Seop Shim, Incheon (KR); Woon Bong Joh, Suwon (KR); Jae Suk Sung, Yongin (KR); Soon Gyu Yim, Seongnam (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/689,011

(22) Filed: Jan. 18, 2010

(30) Foreign Application Priority Data
Aug. 19, 2009 (KR) 10-2009-0076876

(51) Int. Cl. G08B 13/14

(52) U.S. Cl. 340/572.7

(57) ABSTRACT

A radio frequency identification (RFID) tag includes a circuit chip including a pad for an electrical connection on one surface thereof, a molding part receiving the circuit chip therein while exposing the pad to the outside, and an antenna formed on an outer surface of the molding part, having a predetermined pattern shape and electrically connected to the pad.

### CROSS-REFERENCE TO RELATED APPLICATIONS

This application claims the priority of Korean Patent Application No. 10-2009-0076876 filed on Aug. 19, 2009, in the Korean Intellectual Property Office, the disclosure of which is incorporated herein by reference.

### BACKGROUND OF THE INVENTION

1. Field of the Invention

The present invention relates to a radio frequency identification tag, and a method and mold for manufacturing the same, and more particularly, to a radio frequency identification tag that is readable in a non-contact state, and a method and mold for manufacturing the same.

2. Description of the Related Art

A radio frequency identification tag (hereinafter, ‘RFID tag’) is readable in a non-contact state, unlike a barcode or the like, which can be read only in a contact state.

According to the use of power sources, there are active RFID tags provided with power sources, and passive RFID tags having no power sources. Also, RFID tags are classified as either a low-frequency system or a high-frequency system, according to the utilized frequency band.

A passive RFID tag typically includes a dielectric member having a plate shape, an integrated circuit (IC) chip placed on the surface of the dielectric member, and an antenna electrically connected to the IC chip.

The antenna of the passive RFID tag receives a radio signal of electromagnetic waves input from a reader (not shown), thereby creating induced current in an electric circuit. Due to this current, information stored in the IC chip is converted into electromagnetic waves, and is then transmitted to the reader through the antenna.

The reader reads the signal from the RFID tag to thereby identify the information stored in the RFID tag. Typically, such RFID tags are built in or attached to products related to stored information.

However, the RFID tag is difficult to mount on a curved surface as in a portable-phone case, due to the dielectric member having a plate shape. Also, if the RFID tag has a substantial thickness, an electronic device provided with the RFID tag may not have a slim profile. Therefore, techniques for overcoming the above limitations are required.

### SUMMARY OF THE INVENTION

An aspect of the present invention provides an RFID tag that is mountable on a curved surface and capable of achieving a reduction in thickness, and a method and mold for manufacturing the same.

According to an aspect of the present invention, there is provided a radio frequency identification (RFID) tag including: a circuit chip including a pad for an electrical connection on one surface thereof; a molding part receiving the circuit chip therein while exposing the pad to the outside; and an antenna formed on an outer surface of the molding part, having a predetermined pattern shape and electrically connected to the pad.

The outer surface of the molding part may be a curved surface, and the antenna may be formed by jetting a conductive material onto the curved surface of the molding part.

The pad may protrude to the outside of the circuit chip.

The pad may be mounted in the circuit chip to be exposed to the outside of the circuit chip.

The RFID tag may further include a protector disposed on the molding part and protecting the antenna and the circuit chip.

The RFID tag may further include a cover molded on the molding part to cover the antenna and the circuit chip.

According to another aspect of the present invention, there is provided a method of manufacturing a radio frequency identification (RFID) tag, the method including: disposing a circuit chip in a mold, the circuit chip including a pad for an electrical connection on one surface thereof; filling the mold with a resin material and forming a molding part receiving the circuit chip therein while exposing the pad to the outside; and forming an antenna on a surface of the molding part, the antenna being electrically connected to the circuit chip.

The surface of the molding part may be a curved surface, and the antenna may be formed by jetting a conductive material onto the surface of the molding part.

The pad may be exposed to the outside of the circuit chip, and the antenna may be connected to the pad by jetting a conductive material onto the surface of the molding part.

The method may further include forming a protector on the molding part in order to protect the circuit chip and the antenna.

The method may further include forming a cover on the molding part in order to cover the antenna and the circuit chip.

According to another aspect of the present invention, there is provided a mold for manufacturing a radio frequency identification (RFID) tag, the mold including: a mold providing an inner space to receive therein a circuit chip including a pad for an electrical connection on one surface of the circuit chip; and a resin injection part disposed in the mold and causing a resin material to flow into the inner space such that a molding part of the RFID tag is formed in the inner space.

The inner space of the mold may have a shape causing a surface of the molding part to be curved.

The mold may further include a cover mold having an inner space to form a cover covering the antenna and the circuit chip on the surface of the molding part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an RFID tag according to an exemplary embodiment of the present invention;

FIG. 2 is a cross-sectional view illustrating the RFID tag of FIG. 1;

FIGS. 3A through 3D are perspective views for explaining a method of manufacturing the RFID tag of FIG. 1, according to an exemplary embodiment of the present invention;

FIG. 4 is a cross-sectional view illustrating an RFID tag according to another exemplary embodiment of the present invention;

FIG. 5 is a plan view of the RFID tag of FIG. 4;

FIG. 6 is a cross-sectional view illustrating an RFID tag including a cover of the RFID tag of FIG. 4;

FIG. 7 is a cross-sectional view illustrating an RFID tag according to another exemplary embodiment of the present invention;

FIG. 8 is a cross-sectional view illustrating a mold for manufacturing an RFID tag according to an exemplary embodiment of the present invention; and

FIG. 9 is a cross-sectional view illustrating a cover mold for manufacturing a cover for an RFID tag according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

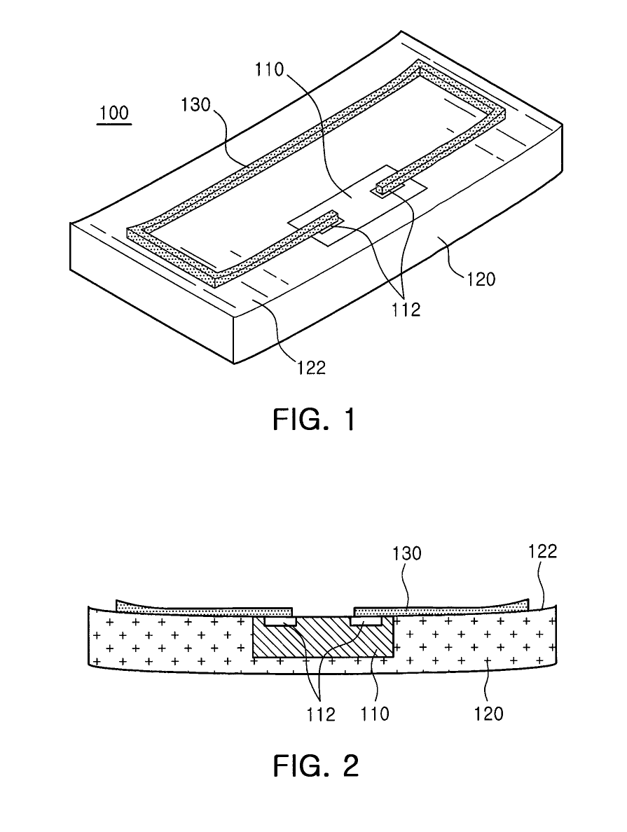

An RFID tag and a method and mold for manufacturing an RFID tag, according to exemplary embodiments of the present invention, will be described in detail with reference to FIGS. 1 through 9.

FIG. 1 is a schematic perspective view illustrating an RFID tag according to an exemplary embodiment of the present invention, and FIG. 2 is a cross-sectional view illustrating the RFID tag of FIG. 1.

Referring to FIGS. 1 and 2, an RFID tag 100 may include a circuit chip 110, a molding part 120, and an antenna 130.

The circuit chip 110 is built into the molding part 120 with its one surface exposed, and pads 112 may be disposed on the exposed one surface for an electrical connection. Here, the circuit chip 110 may receive power by radio through the antenna 130 electrically connected thereto. The circuit chip 110 is activated by the power received by radio to thereby transmit/receive radio signals with an external RFID reader via the antenna 130.

The circuit chip 110 processes reception/transmission signals into digital data. The circuit chip 110 recognizes a request of the reader on the basis of digital reception data from the reader, and outputs transmission data, desired information, according to the request of the reader. In the above-described way, the circuit chip 110 and the reader share information between each other.

The pads 112 may be exposed on the one surface of the circuit chip 110, and may contact the antenna 130 having a predetermined frequency to thereby electrically connect the circuit chip 110 with the antenna 130. The pads 112 may be placed inside the molding part 120, and do not protrude to the outside of the molding part 120.

The molding part 120 may be injection-molded to receive therein the circuit chip 110 while exposing the pads 112 of the circuit chip 110 to the outside. Here, the molding part 120 may be formed by injecting an insulating material into a mold.

The molding part 120 may have a curved surface 122 and thus be easily adaptable to a personal portable terminal or the like. Such a molding part 120 allows for the application of the present invention to a variety of electronic devices.

The antenna 130 is disposed along the curved surface 122 of the molding part 120 so as to be electrically connected to the circuit chip 110.

Here, the personal portable terminal refers to any terminal with mobility, which is easy to carry, capable of data communications via mobile communications networks or satellite communications networks, and capable of receiving a variety of image information including still images or moving pictures. Examples of the terminal may include a portable terminal, a personal digital assistant (PDA) or the like.

The molding part 120 may itself serve as a case of a personal portable terminal.

The antenna 130 is disposed on the curved surface 122 of the molding part 120 and has a shape with four corners. Both ends of the antenna 130 contact the pads 112 of the circuit chip 110, respectively. However, the antenna 130 is not limited to the described shape, and may be produced to have a predetermined pattern shape according to a designer's intention.

The antenna 130 has a predetermined frequency at which a radio signal is receivable and transmittable between the antenna 130 and an external RFID reader.

The antenna 130 may be formed along the curved surface 122 of the molding part 120 by jetting a conductive material onto the curved surface 122 of the molding part 120.

Consequently, the antenna 130 is formed on the curved surface 122 of the molding part 120 through a single process. This allows for the omission of the separate process of electrically connecting the antenna 130 to the circuit chip 110, thereby shortening the manufacturing process. Also, the jetting of the conductive material allows the antenna 130 to be connected to the circuit chip 110 with precision, thereby enhancing the reliability of an electrical connection.

In addition, the RFID tag of this embodiment is subjected to the injection-molding that allows the circuit chip 110 to be placed within the molding part 120, thereby achieving a reduction in overall thickness.

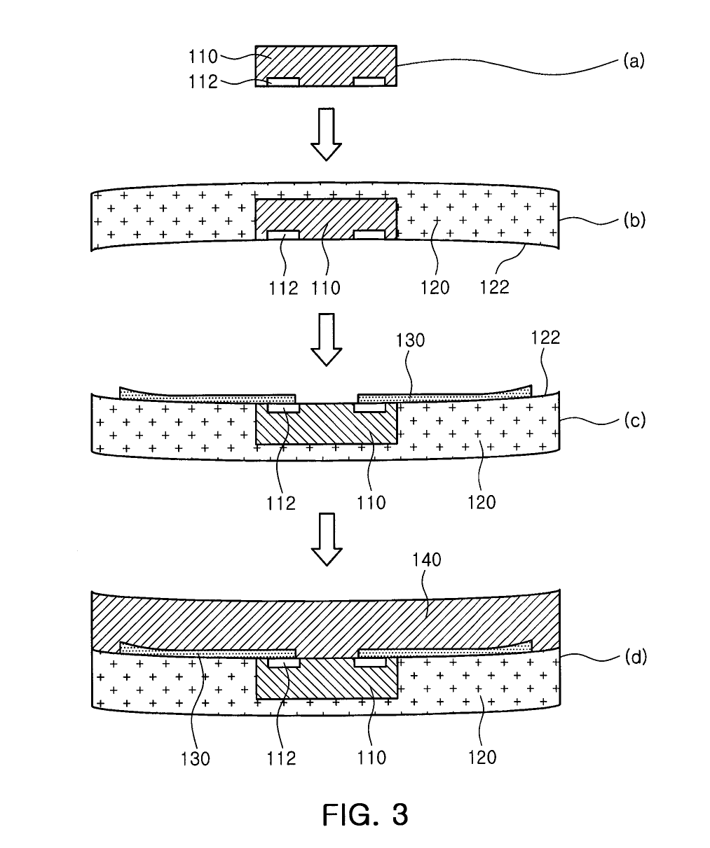

FIGS. 3A through 3D are perspective views for explaining a method of manufacturing the RFID tag, according to an exemplary embodiment of the present invention.

Referring to FIG. 3A, the method of manufacturing the RFID tag may include providing the circuit chip 110 including the pads 112.

Here, the pads 112 formed on the circuit chip 110 are illustrated as not protruding to the outside of the circuit chip 110, but the shape of the pads 112 is not limited to the illustration or description. The circuit chip 110 is disposed is a mold in such a way that the pads 112 are exposed to the outside.

After the circuit chip 110 is disposed in the mold, as shown in FIG. 3B, the molding part 120 receiving the circuit chip 110 therein is formed while exposing the pads 112 to the outside.

The molding part 120 may have a curved outer surface. However, the molding part 120 is not limited to this curved shape, and may be produced to have a shape corresponding to a case of an electronic device.

Subsequently, the antenna 130 may be formed on the surface of the molding part 120 to be electrically connected to the circuit chip 110.

As shown in FIG. 3C, due to the curved outer surface of the molding part 120, the antenna 130 is formed by jetting a conductive material onto the curved outer surface of the molding part 120, rather than by using a typical printing method.

As shown in FIG. 3D, this RFID tag 100 may be disposed in a mold again and then a cover 140 may be formed therein.

Accordingly, the RFID tag and the method of manufacturing the same, according to this embodiment, include the molding part 120 that is injection-molded to receive therein the circuit chip 110 capable of radio communications. This achieves a reduction in thickness, as compared to the case in which the circuit chip 110 is adhered onto the molding part 120.

Also, in the RFID tag and the method of manufacturing the same, according to this embodiment, the injection-molded molding part 120 can be produced freely to have a curved shape or the like. Thus, this molding part 120 may be mounted on a curved electronic device or implemented as an outer case, thereby enhancing the degree of design freedom.

Moreover, in the RFID tag and the method of manufacturing the same, according to this embodiment, the antenna 130 is formed by jetting a conductive material onto the molding part 120 receiving the circuit chip 110 therein. This significantly facilitates an electrical connection, and ensures electrical contact between the antenna 130 and the circuit chip 110, thereby enhancing the reliability of a connection portion.

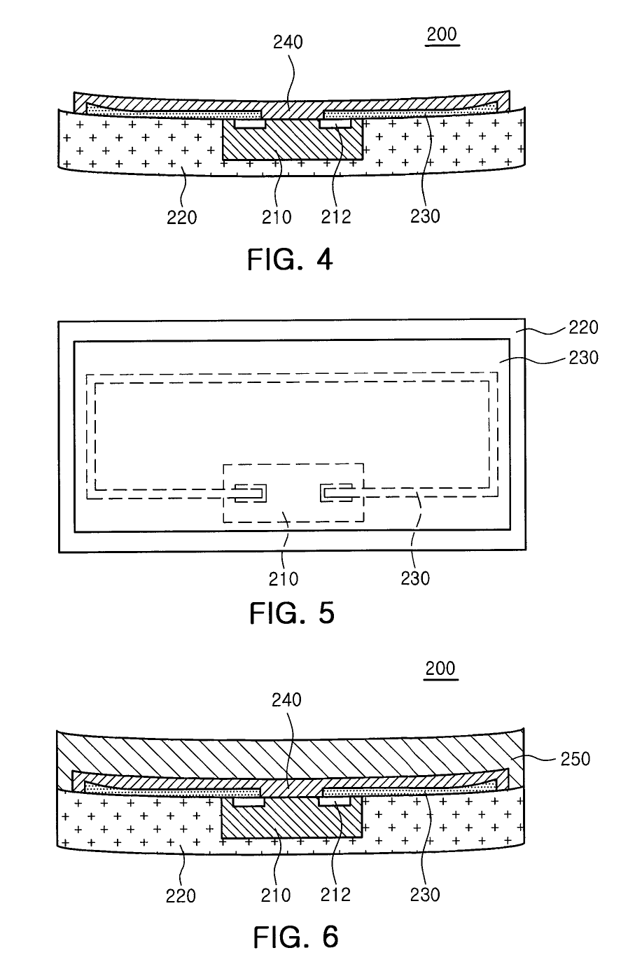

FIG. 4 is a cross-sectional view illustrating an RFID tag according to another exemplary embodiment of the present invention, and FIG. 5 is a plan view illustrating the RFID tag of FIG. 4.

Referring to FIGS. 4 and 5, an RFID tag 200 may include a circuit chip 210, a molding part 220, an antenna 220 and a protector 240.

According to this embodiment, the circuit chip 210, the molding part 200 and the antenna 230 are substantially identical to those of the previous embodiment. Thus, detailed descriptions thereof may be omitted.

The protector 240 may be disposed on the molding part 220 to cover the circuit chip 210 and the antenna 230 entirely. The protector 240 protects the antenna 230 and the circuit chip 210.

The protector 240 may be formed of a polymer material having a damper function, but is not limited to the described material. A variety of materials such as a ferrite magnetic substance or the like may be selectively used for the protector 240.

Accordingly, the RFID tag, according to this embodiment, primarily absorbs any impact from external environments with the protector 240, so that its internal structure can be protected.

FIG. 6 is a cross-sectional view for explaining a cover for the RFID tag of FIG. 4.

Referring to FIG. 6, after the RFID tag 200 is disposed in a mold, a cover 250 may be injection-molded on the outer surface of the molding part 220 to cover the antenna 230 and the protector 240.

The cover 250 formed in the above manner may have a curved surface like the surface of the molding part 220. The shape of the cover 250 may be set freely according to a designer's intention.

Accordingly, the RFID tag according to this embodiment may have the circuit chip 210 and the antenna 230 mounted inside the cover 250. This may diversify the application fields of the RFID tag. For example, the RFID tag may be built into a personal portable terminal or the like in order to function as a bus or subway pass.

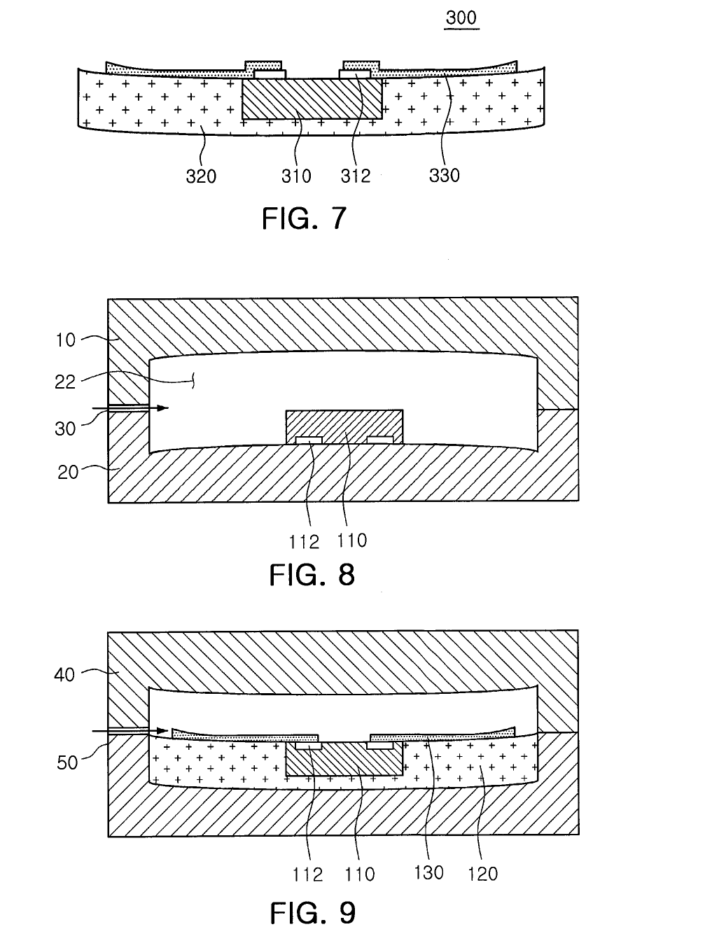

FIG. 7 is a cross-sectional view for explaining an RFID tag according to another exemplary embodiment of the present invention.

Referring to FIG. 7, an RFID tag 300 may include a circuit chip 310, a molding part 320 and antenna 330.

According to this embodiment, the molding part 320 and the antenna 330 are substantially identical to those of the previous embodiment, and detailed descriptions thereof may be omitted. Although a protector or a cover is not illustrated, those elements may be added according to a designer's intention.

The circuit chip 310 may include pads 312 protruding to the outside of the molding part 320. The circuit chip 310 is provided within the molding part 320.

The antenna 330 is formed on the pads 312 by jetting a conductive material and thus is electrically connected to the circuit chip 310. The antenna 330 may cover the side surface and the top surface of each pad 312.

FIG. 8 is a cross-sectional view illustrating a mold for manufacturing an RFID tag according to an exemplary embodiment of the present invention.

Referring to FIG. 8, a mold for manufacturing an RFID tag may include an upper mold 10, a lower mold 20 and a resin injection part 30.

The upper mold 10 and the lower mold 20 contact each other to form an inner space therebetween, and the circuit chip 110 is placed in the center of the lower mold 20. The upper mold 10 and the lower mold 20 are assembled together, and thus may be referred to as a mold as a whole.

The resin injection part 30 is formed at a location where the upper mold 10 and the lower mold 20 meet each other. However, the location of the resin injection part 30 is not limited, and may be varied according to a designer's intention.

Accordingly, a resin material is injected into the inner space 22 through the resin injection part 30 (see an arrow in FIG. 8). The resin material fills the inner space 22, forming the exterior of a molding part.

Thus, the molding part may be produced to have various shapes with a curved surface by freely changing the shape of the inner space of the mold.

FIG. 9 is a cross-sectional view illustrating a cover mold for manufacturing a cover for an RFID tag according to an exemplary embodiment of the present invention.

Referring to FIG. 9, a cover mold 40 having an inner space may be provided, and the molding part 120 is received in the cover mold 40 in order to cover the antenna 130 and the circuit chip 110 formed on the surface of the molding part 120.

Here, a resin material may be injected through an injection hole 50 in the cover mold 40 (see an arrow in FIG. 9). As the resin material fills the inner space of the cover mold 40, a cover having a shape corresponding to the RFID tag is formed.

Although not shown in FIG. 9, the RFID tag may further include a protector disposed on the molding part 120 to entirely cover the circuit chip 110 and the antenna 130.

Accordingly, the cover allows the circuit chip 110 and the antenna 130 to be placed within the RFID tag.

As set forth above, according to exemplary embodiments of the invention, the RFID tag and the method and mold for manufacturing the same can achieve a reduction in thickness since the circuit chip is received within the molding part.

Also, in the RFID tag, and the method and mold for manufacturing the same, the molding part is formed in a mold so as to have a curved shape and receive the circuit chip therein, thereby facilitating the mounting thereof on an electronic device with a curved shape.

In addition, in the RFID tag, and the method and mold for manufacturing the same, the antenna is formed on the molding part receiving therein the circuit chip and is electrically connected to the circuit chip, thereby facilitating a process for an electrical connection.

While the present invention has been shown and described in connection with the exemplary embodiments, it will be apparent to those skilled in the art that modifications and variations can be made without departing from the spirit and scope of the invention as defined by the appended claims.

What is claimed is:

1. A radio frequency identification (RFID) tag comprising:
a circuit chip including a pad for an electrical connection on one surface thereof;
a molding part receiving the circuit chip therein while exposing the pad to the outside; and
an antenna formed on an outer surface of the molding part, having a predetermined pattern shape and electrically connected to the pad.

2. The RFID tag of claim 1, wherein the outer surface of the molding part is a curved surface, and the antenna is formed by jetting a conductive material onto the curved surface of the molding part.

3. The RFID tag of claim 1, wherein the pad protrudes to the outside of the circuit chip.

4. The RFID tag of claim 1, wherein the pad is mounted in the circuit chip to be exposed to the outside of the circuit chip.

5. The RFID tag of claim 1, further comprising a protector disposed on the molding part and protecting the antenna and the circuit chip.

6. The RFID tag of claim 1, further comprising a cover molded on the molding part to cover the antenna and the circuit chip.

7. A method of manufacturing a radio frequency identification (RFID) tag, the method comprising:
disposing a circuit chip in a mold, the circuit chip including a pad for an electrical connection on one surface thereof;
filling the mold with a resin material and forming a molding part receiving the circuit chip therein while exposing the pad to the outside; and
forming an antenna on a surface of the molding part, the antenna being electrically connected to the circuit chip.

8. The method of claim 7, wherein the surface of the molding part is a curved surface, and the antenna is formed by jetting a conductive material onto the surface of the molding part.

9. The method of claim 7, wherein the pad is exposed to the outside of the circuit chip, and the antenna is connected to the pad by jetting a conductive material onto the surface of the molding part.

10. The method of claim 7, further comprising forming a protector on the molding part to protect the circuit chip and the antenna.

11. The method of claim 7, further comprising forming a cover on the molding part to cover the antenna and the circuit chip.

12. A mold for manufacturing a radio frequency identification (RFID) tag, the mold comprising:
a mold providing an inner space to receive therein a circuit chip including a pad for an electrical connection on one surface of the circuit chip; and
a resin injection part disposed in the mold and causing a resin material to flow into the inner space such that a molding part of the RFID tag is formed in the inner space.

13. The mold of claim 12, wherein the inner space of the mold has a shape causing a surface of the molding part to be curved.

14. The mold of claim 12, further comprising a cover mold having an inner space to form a cover covering the antenna and the circuit chip on the surface of the molding part.
